(19) United States
(12) Patent Application Publication
(10) Pub. No.: US 2025/0021382 A1
(43) Pub. Date: Jan. 16, 2025

(54) Converting Functions to Microservices

(71) Applicant: Dell Products L.P., Round Rock, TX (US)

(72) Inventors: Yair Yotam, Beer Sheva (IL); Boris Shpilyuck, Ashdod (IL); Igor Dubrovsky, Beer Sheva (IL)

(21) Appl. No.: 18/352,780

(22) Filed: Jul. 14, 2023

(51) Int. Cl. G06F 9/48

(52) U.S. Cl. CPC G06F 9/4887

(57) ABSTRACT

A system can monitor a containerized function for a number of iterations of the containerized function. The system can, for the respective iterations, determine respective upper limits of amounts of time for which the containerized function is idle, and determine respective numbers of cold starts of the containerized function. The system can determine whether a percentage of the respective iterations, for which corresponding upper limits, of the respective upper limits, on amount of time for which the containerized function is idle, is below a threshold idleness value, and for which corresponding numbers of cold starts, of the respective numbers of cold starts, are above a threshold cold start value. The system can, in response to determining that the percentage of the respective iterations is above a threshold successful probes value, deploy a microservice that is configured to execute the function.

### BACKGROUND

A computer function can generally comprise a portion of computer-executable code that performs a task, and can be distinguished from a pure mathematical function.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can execute a group of containerized functions. The system can monitor a containerized function of the group of containerized functions for a number of iterations of the containerized function, respective iterations of the number of iterations being for a defined amount of time, wherein the containerized function is configured to execute a function. The system can, for the respective iterations, determine respective upper limits of amounts of time for which the containerized function is idle, and determine respective numbers of cold starts of the containerized function. The system can determine whether a percentage of the respective iterations, for which corresponding upper limits, of the respective upper limits, on amount of time for which the containerized function is idle, is below a threshold idleness value, and for which corresponding numbers of cold starts, of the respective numbers of cold starts, are above a threshold cold start value. The system can, in response to determining that the percentage of the respective iterations is above a threshold successful probes value, deploy a microservice that is configured to execute the function, and terminate deployment of the containerized function.

An example method can comprise monitoring, by a system comprising a processor, a containerized function for recurring measurement periods. The method can further comprise, for respective recurring measurement periods of the recurring measurement periods, determining, by the system, respective upper limit idle times of the containerized function, and determining, by the system, respective numbers of cold starts of the containerized function. The method can further comprise determining, by the system, a percentage of the recurring measurement periods where any respective upper limit idle times of the respective upper limit idle times are below a first value, and where any respective number of cold starts of the respective numbers of cold starts are above a second value. The method can further comprise, in response to determining that the percentage of the recurring measurement periods is above a threshold percentage of successful probes, deploying, by the system, a microservice that is configured to execute a function that corresponds to the containerized function.

An example non-transitory computer-readable medium can comprise instructions that, in response to execution, cause a system comprising a processor to perform operations. These operations can comprise, for recurring measurement periods during which a containerized function is monitored, determining respective upper limit idle times of the containerized function, and determining respective numbers of cold starts of the containerized function. These operations can further comprise determining a percentage of the recurring measurement periods for which at least one respective upper limit idle time of the respective upper limit idle times is below a first value, and for which at least one respective number of cold start of the respective numbers of cold starts is above a second value. These operations can further comprise, in response to determining that the percentage of the recurring measurement periods is above a threshold percentage of successful probes, deploying a microservice that has been determined to be able to execute a function that corresponds to the containerized function.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate converting functions to microservices, in accordance with an embodiment of this disclosure;

FIG. 2 illustrates an example system architecture that can facilitate converting functions to microservices, in accordance with an embodiment of this disclosure;

FIG. 3 illustrates an example system architecture for converting a function to a microservice, and that can facilitate converting functions to microservices, in accordance with an embodiment of this disclosure;

FIG. 4 illustrates an example system architecture for converting a microservice to a function, and that can facilitate converting functions to microservices, in accordance with an embodiment of this disclosure;

FIG. 5 illustrates an example process flow that can facilitate converting functions to microservices, in accordance with an embodiment of this disclosure;

FIG. 6 illustrates another example process flow that can facilitate converting functions to microservices, in accordance with an embodiment of this disclosure;

FIG. 7 illustrates another example process flow that can facilitate converting functions to microservices, in accordance with an embodiment of this disclosure;

FIG. 8 illustrates another example process flow that can facilitate converting functions to microservices, in accordance with an embodiment of this disclosure;

FIG. 9 illustrates another example process flow that can facilitate converting functions to microservices, in accordance with an embodiment of this disclosure;

FIG. 10 illustrates another example process flow that can facilitate converting functions to microservices, in accordance with an embodiment of this disclosure;

FIG. 11 illustrates an example block diagram of a computer operable to execute an embodiment of this disclosure.

### DETAILED DESCRIPTION

### Overview

Functions as a Service (FaaS) can comprise a service allocated by a cloud platform to achieve a “serverless” execution model. In this form of execution, a cloud services platform can be leveraged to control most aspects of execution layers, allowing the developer to focus on business logic.

Using a FaaS platform to execute code can provide benefits. A benefit can be an improved time to market, where developers are focused on business value rather than operational aspects of deployment and maintenance, which can facilitate faster development cycles.

Another benefit can relate to compute resources and cost. A characteristic of containerized functions can be ephemerality, where functions can be short-lived and can scale to zero. Using a FaaS platform can benefit a system in terms of cost and compute resources, where some part of an application remains dormant until needed.

A problem with a FaaS can relate to relatively slow execution of containerized functions relative to their microservice counterpart due to “cold starts.” The present techniques can be implemented to facilitate automatic conversion of highly utilized functions with frequent “cold starts” to microservices. It can be that a microservice is always up and running (when the microservice and a system that hosts the microservice are functioning properly) so that a microservice is not subject to a cold start problem in the same way that a containerized function is.

It can be that starting a function after some idle period introduces a “cold start,” where the function is provisioned before an actual call can be made against that function. That is, it can be that an active instance of a function has been terminated because the function has been idle (because no calls to it have been made), so the function needs to be provisioned to have an active instance running that can service calls to it. Such a cold start can extend a response time relative to an actively-running instance, which can negatively impact service level agreement (SLA) metrics (such as latency in response time).

Simultaneous cold starts of multiple functions can also introduce resource consumption spikes, which can lead to temporary resource starvation of a system that hosts the functions. Given these problems with cold starts of functions, it can be, in some examples, that using microservices that are always running can be a better approach.

In one example scenario, a function is mostly busy. Rare cold starts can occur after rare periods of inactivity. In such a scenario, FaaS implementations and microservice implementations can produce similar results. A FaaS implementation can have an advantage of consuming fewer resources due to the minor function idle time. A microservice implementation can have an advantage of avoiding a cold start.

In another example scenario, a function is mostly idle. Rare invocations of the function can introduce a cold start. In this case, invoking the function does cause a cold start, but since the function is idle most of the time, a function implementation can have an advantage over a microservice implementation in terms of resource consumption.

In a third example scenario, a function is mostly busy, but has frequent short periods of inactivity that can introduce cold starts. In this scenario, using a microservice can have an advantage over a function implementation, because a cold start burden can be significant with functions, and a resource consumption savings (relative to a microservice) due to function idle time can be small.

The present techniques can be implemented to identify when this third example scenario occurs, and then convert a function to a microservice.

A system that implements the present techniques can use the following parameters, which, in some examples, it can receive as user input:

A recurring measurement period. Metrics can be collected for this length of time, and there can be multiple of these periods for which metrics are collected.

Maximum idle time (MIT). Where a measured idle time per measurement period is greater than the MIT, then it can be that a conversion of a function to a microservice does not occur.

Minimal cold starts count (MCSC). Where a number of cold starts period is less than the MCSC, then it can be that a conversion of a function to a microservice does not occur.

Percentage of successful probes (PSP). This can indicate during what percentage of measurement periods MIT and MCSC metrics should be met to convert a function to a microservice.

Minimal measurement periods count (MMPC). This can indicate a minimum number of measurement periods that should be observed before a decision on whether to convert a function to a microservice is made.

With these configuration parameters, operation of a function can be monitored with respect to cold starts and idle time through a number of measurement periods equal to at least the MMPC. If MIT and MCSC metrics are met to at least the PSP level, then the function can be converted to a microservice.

In some examples, when a percentage of successful measurements of MIT and MCSC metrics drops below the PSP level, the microservice can be converted back into a function.

The present techniques can be implemented to facilitate automatic conversion of highly-utilized functions with frequent “cold starts” to microservices. A benefit of this approach can involve lowering an impact of cold starts on SLA metrics, and avoiding resource consumption spikes that can lead to unpredictable system behavior.

A microservice can generally comprise a computer service that can be invoked according to an application programming interface (API). A microservice can generally execute in conjunction with multiple other microservices (which can invoke each other) to provide a computer service. In some examples, a particular operation can be effectuated as a computer function or as a microservice—the operation itself can be performed the same way regardless of whether it is implemented in a function or a microservice.

Both microservices and functions can implement some business logic. A difference can be that a microservice is an always up-and-running process, while function's process is created upon demand and gets shut down when its mission is complete.

Consider the following example, where there is a report generation for executives in an organization. a microservice (that implements this reporting logic) can be always up-and-running, and when request for report generation arrives to this microservice, it fulfills the request. In contrast, where this reporting logic is implemented as a function, it can be that the function is started to perform this report, and upon completion the function will be shut down. Upon an additional request for report generation, the same start/shut down cycle of the function can occur again.

### Example Architectures

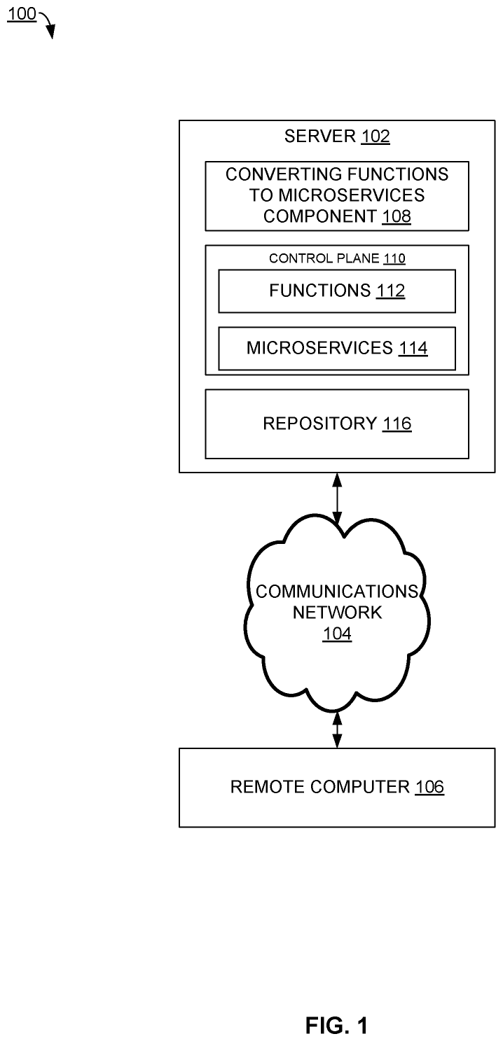

FIG. 1 illustrates an example system architecture 100 that can facilitate converting functions to microservices in accordance with an embodiment of this disclosure.

System architecture 100 comprises server 102, communications network 104, and remote computer 106. In turn, server 102 comprises converting functions to microservices component 108, control plane 110 (which comprises functions 112 and microservices 114), and repository 114.

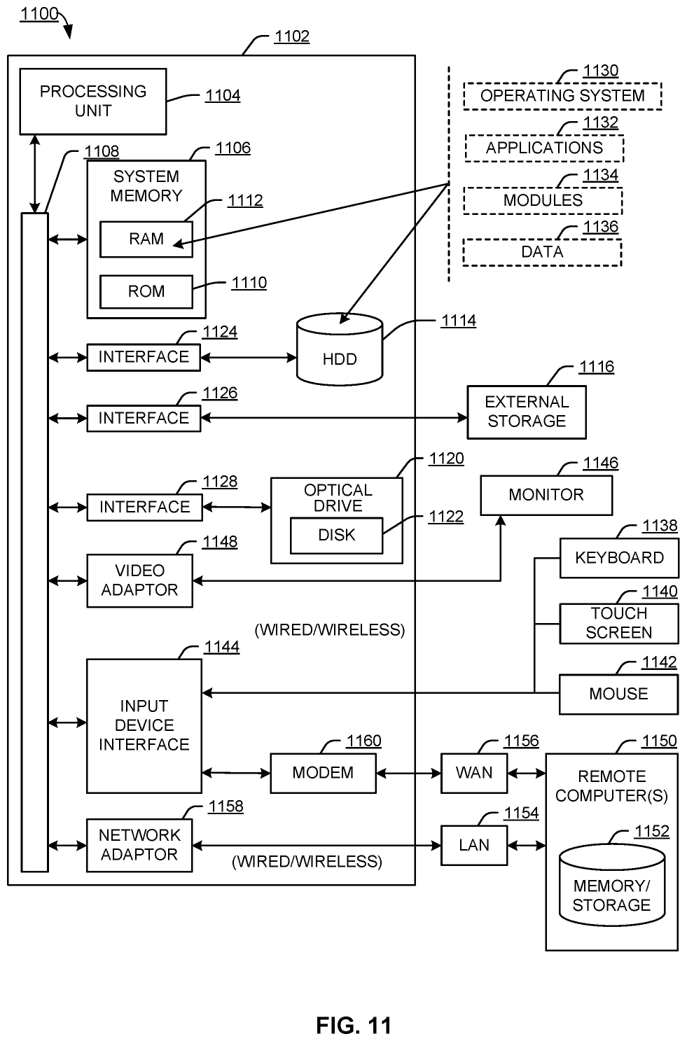

Each of server 102 and/or remote computer 106 can be implemented with part(s) of computing environment 1100 of FIG. 11. Communications network 104 can comprise a computer communications network, such as the Internet.

Control plane 110 can generally manage deployed functions 112 and microservices 114. In some examples, different control planes manage functions 112 and microservices 114. Respective functions of functions 112 can comprise computer-executable code that can be invoked, and respective microservices of microservices 114 can comprise computer-executable code that can be invoked. Repository 116 can store uncompiled code of functions 112 and microservices 114 that can be compiled and deployed to control plane 110.

Remote computer 106 can contact server 102 via communications network 104 to invoke functions of functions 112 and/or microservices of microservices 114, such as those that comprise a web application. Converting functions to microservices component 108 can identify functions of functions 112 that can be converted into microservices of microservices 114 (or vice versa), and effectuate that change.

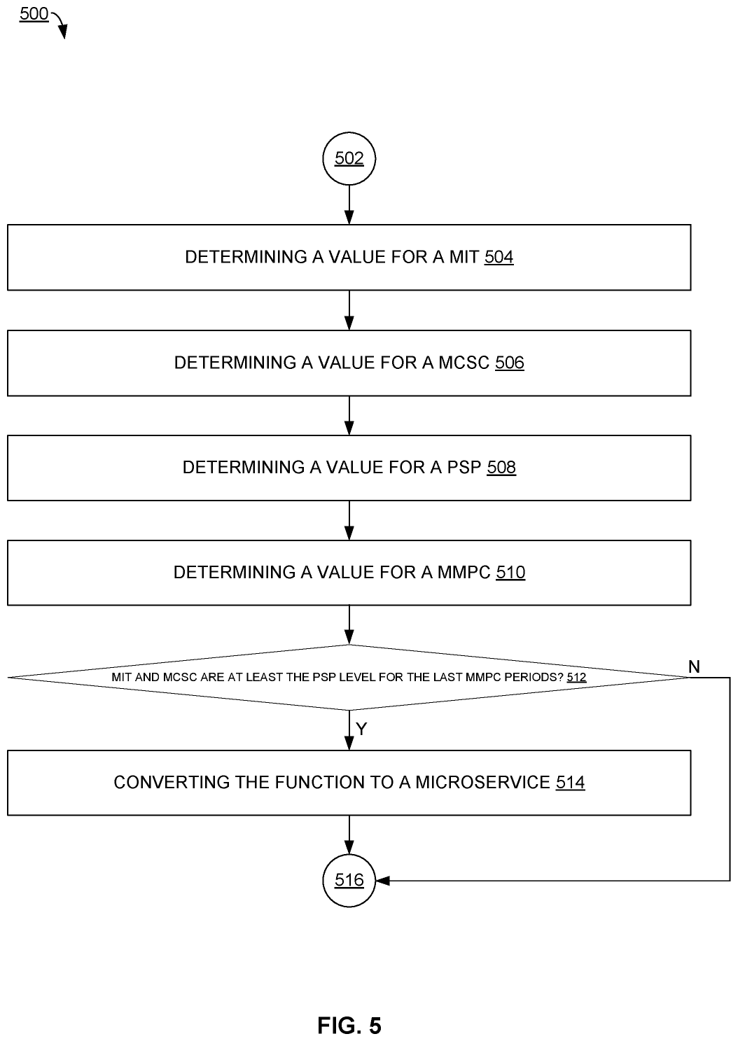

In some examples, converting functions to microservices component 108 can implement part(s) of the process flows of FIGS. 5-10 to implement converting functions to microservices.

It can be appreciated that system architecture 100 is one example system architecture for generating and distributing security policies in a containerized environment, and that there can be other system architectures that facilitate generating and distributing security policies in a containerized environment.

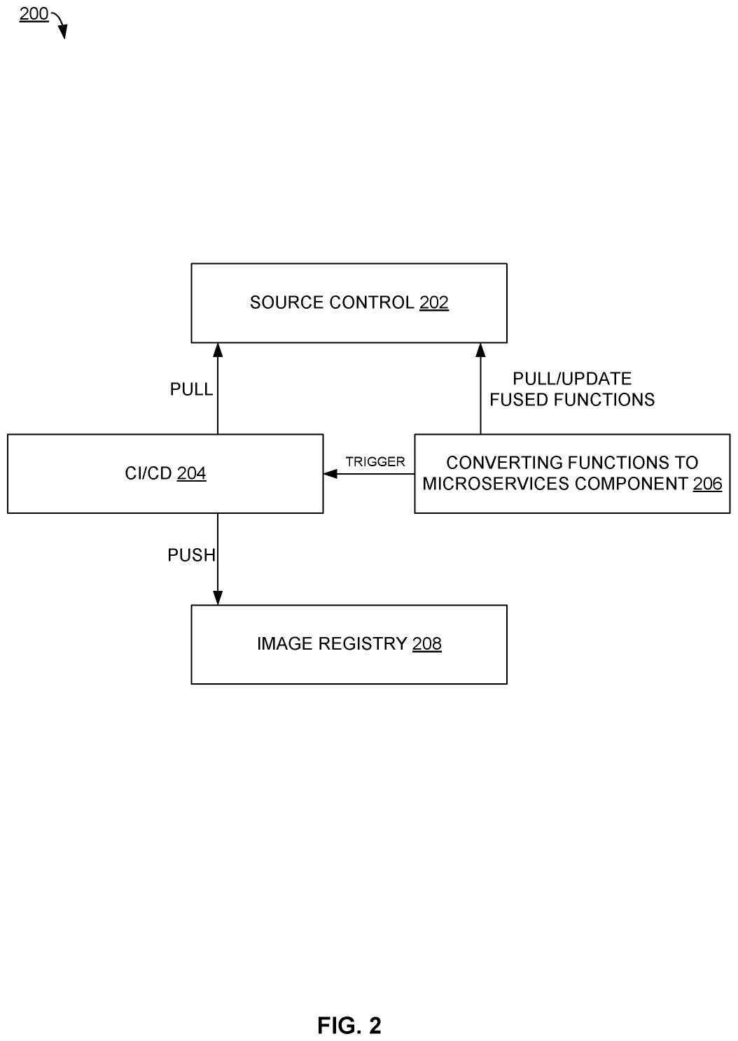

FIG. 2 illustrates an example system architecture 200 that can facilitate converting functions to microservices, in accordance with an embodiment of this disclosure. In some examples, part(s) of system architecture 200 can be used to implement part(s) of system architecture 100 of FIG. 1 to facilitate converting functions to microservices.

System architecture 200 comprises source control 202, continuous integration (CI)/continuous deployment (CD) 204, converting functions to microservices component 210, and image registry 208.

Source control 202 can be similar to repository 114 of FIG. 1. CI/CD 204 can generally comprise a component that integrates changes to code for a containerized function, and then deploys an image of that containerized function to image registry 208. Image registry 208 can comprise a registry of function container images that can be instantiated and executed when the corresponding function is invoked. Converting functions to microservices component 206 can be similar to converting functions to microservices component 108 of FIG. 1.

Analysis and provisioning can be performed as follows. Converting functions to microservices component 206 can identify a deployed function to be converted to a microservice, and/or a deployed microservice to be converted to a function. Where such a conversion is identified, converting functions to microservices component 206 can cause CI/CD component 204 to pull code for that function from source control 202, to create an image for that serverless function or microservice-equivalent of that serverless function, and push that image to image registry 208 (from where an instance of the image can be deployed, such as to control plane 110 of FIG. 1).

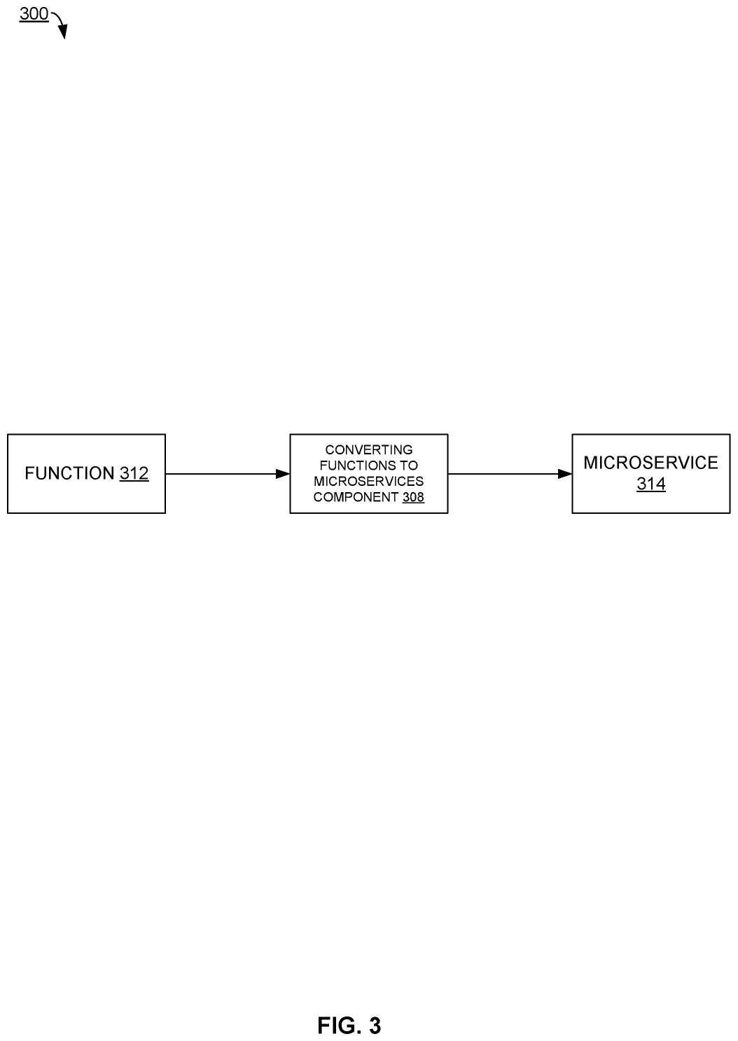

FIG. 3 illustrates an example system architecture 300 for converting a function to a microservice, and that can facilitate converting functions to microservices, in accordance with an embodiment of this disclosure. In some examples, part(s) of system architecture 300 can be used to implement part(s) of system architecture 100 of FIG. 1 to facilitate converting functions to microservices.

System architecture 300 comprises converting functions to microservices component 308 (which can be similar to converting functions to microservices component 108 of FIG. 1), function 312 (which can be similar to a function of functions 112), and microservice 314 (which can be similar to a microservice of microservices 114).

Converting functions to microservices component 308 can convert function 312 to microservice 314. That is, function 312 can comprise a serverless function that executes a function (or operation), and microservice 314 can comprise a microservice that executes that same function (or operation). Whether expressed as a function or a microservice, converting functions to microservices component 308 can obtain the same code from a repository (e.g., repository 116 of FIG. 1), and encapsulate that same code in a serverless function or a microservice.

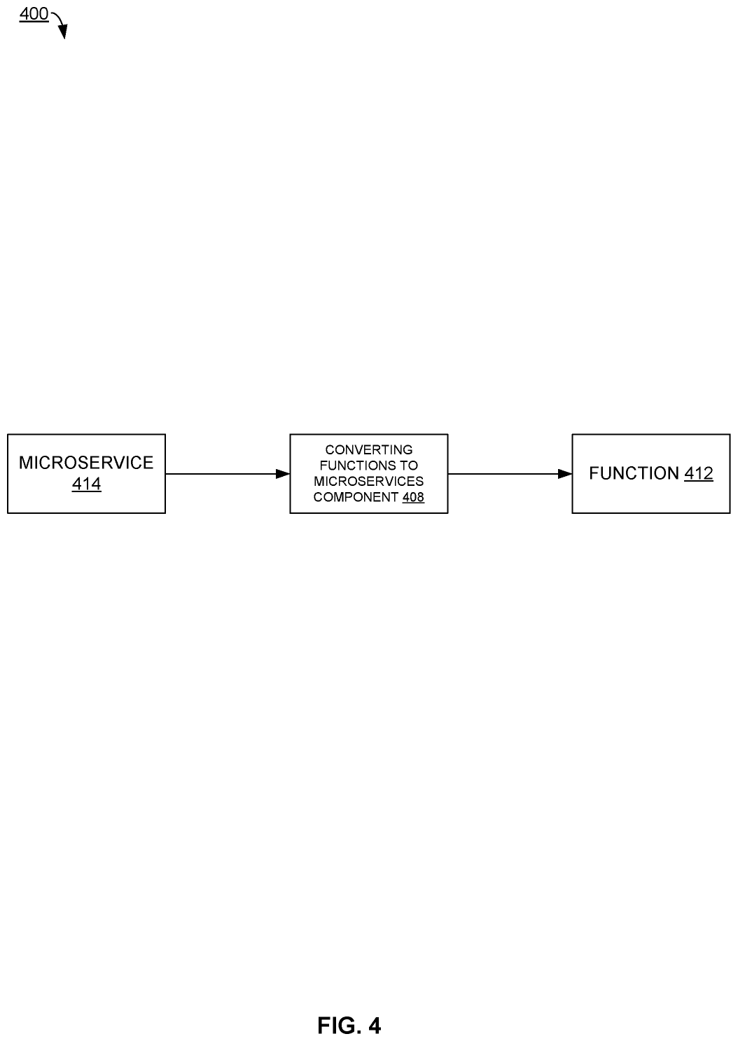

FIG. 4 illustrates an example system architecture 400 for converting a microservice to a function, and that can facilitate converting functions to microservices, in accordance with an embodiment of this disclosure. In some examples, part(s) of system architecture 400 can be used to implement part(s) of system architecture 100 of FIG. 1 to facilitate converting functions to microservices.

System architecture 400 comprises converting functions to microservices component 408 (which can be similar to converting functions to microservices component 108 of FIG. 1), function 412 (which can be similar to a function of functions 112), and microservice 414 (which can be similar to a microservice of microservices 114).

Whereas system architecture 300 of FIG. 3 can be implemented to convert a function to a microservice, system architecture 400 can be implemented to perform the opposite—to convert a microservice back to a function. This can be performed, for example, such as when metrics that indicated converting a function to a microservice are no longer met.

### Example Process Flows

FIG. 5 illustrates an example process flow 500 that can facilitate converting functions to microservices, in accordance with an embodiment of this disclosure. In some examples, one or more embodiments of process flow 500 can be implemented by converting functions to microservices component 108 of FIG. 1, or computing environment 1100 of FIG. 11.

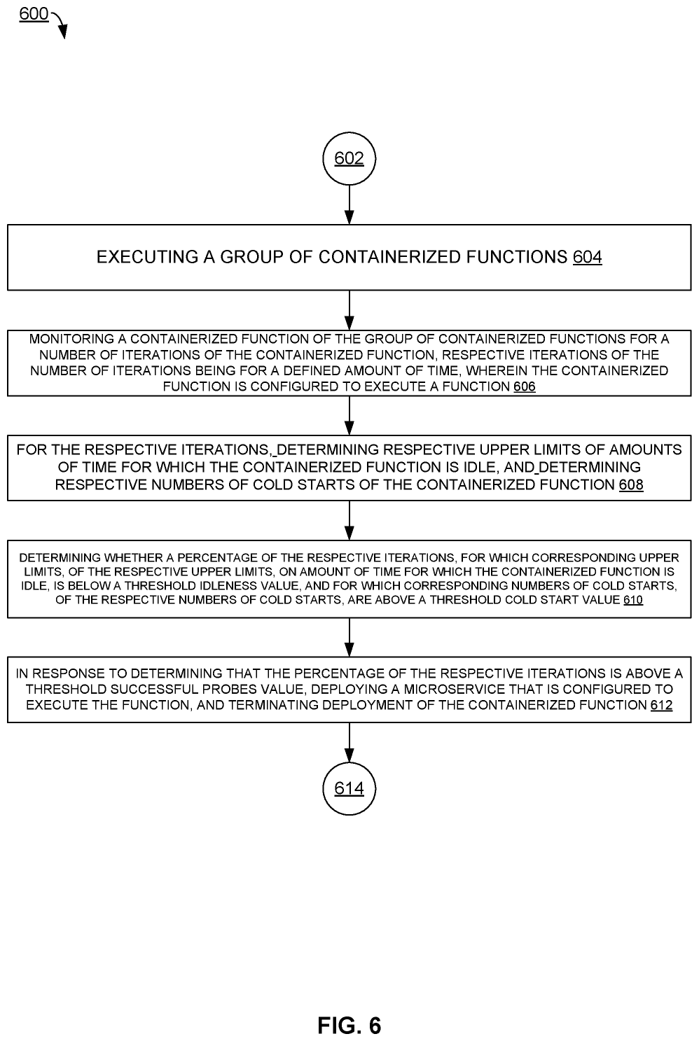

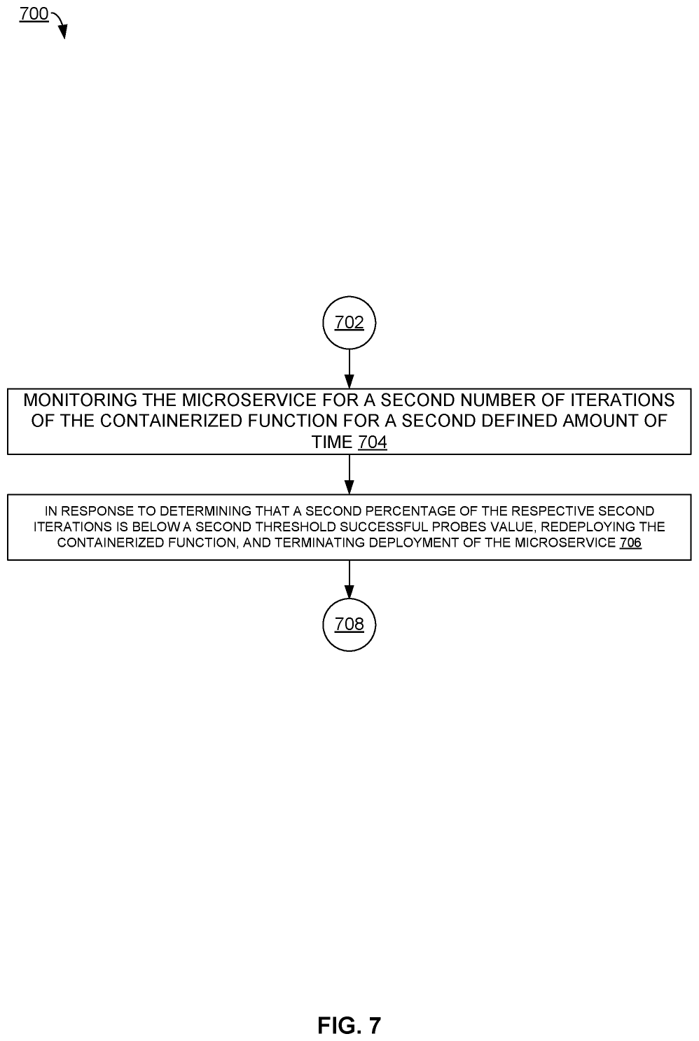

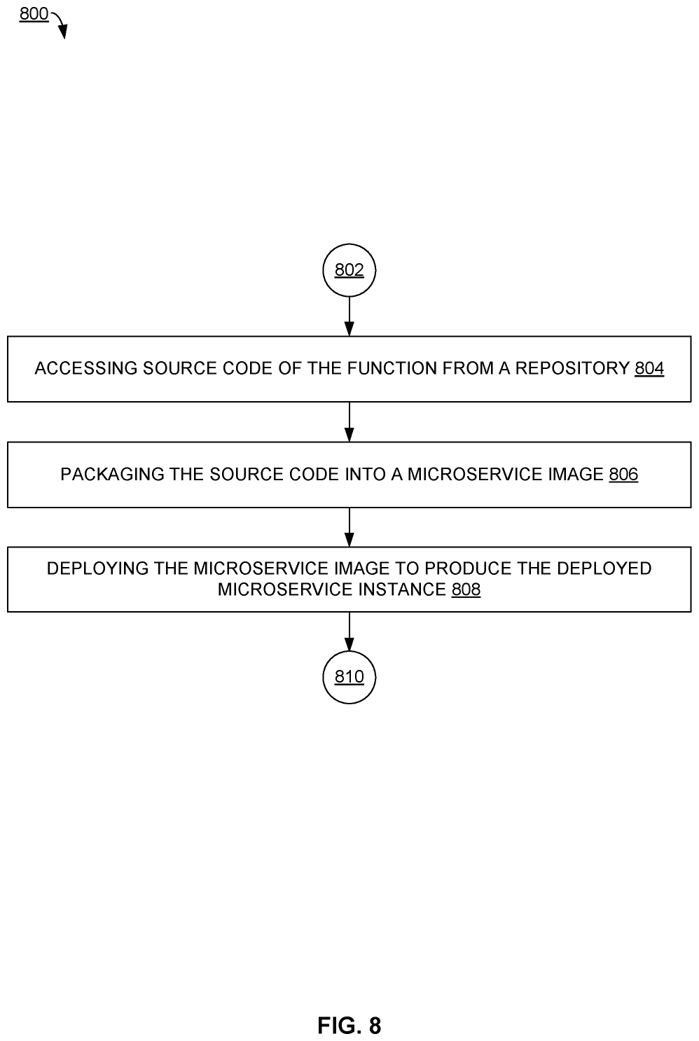

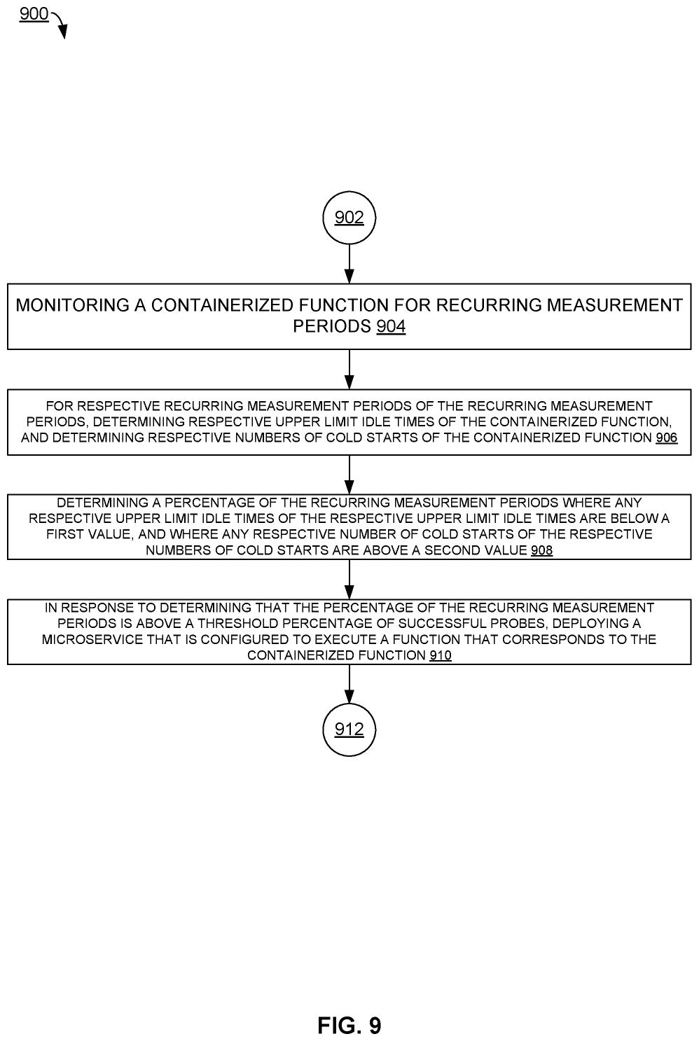

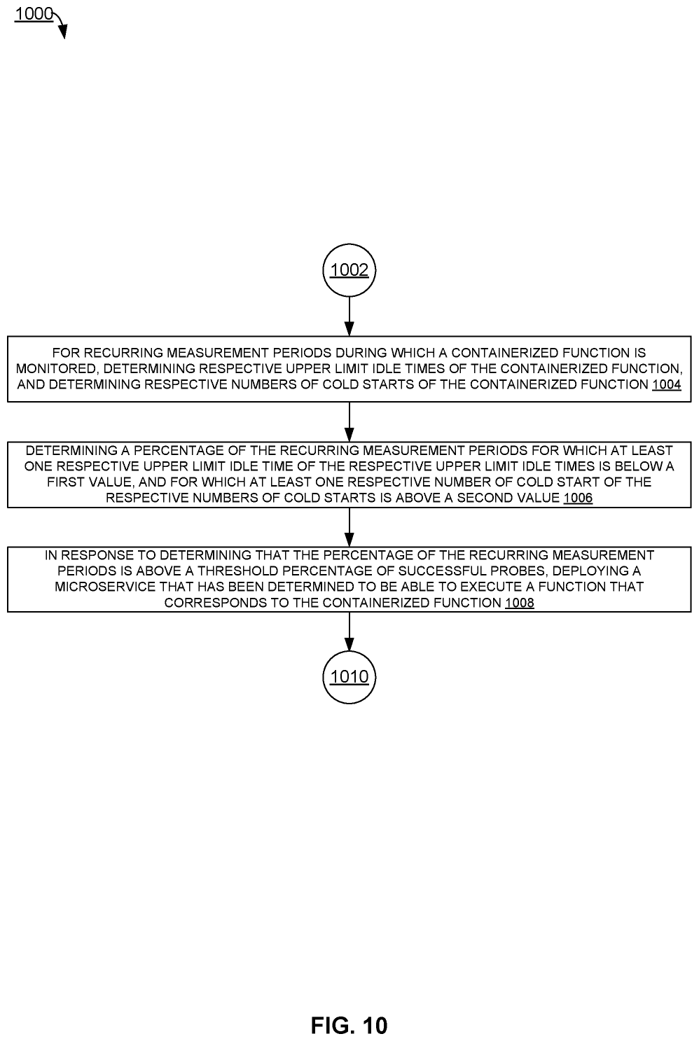

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts determining a value for a MIT. This can be a value for how long a measured idle time per measured period can be to indicate conversion of a function to a microservice. Where a measured idle time per measurement period is greater than the MIT, then it can be that a conversion of a function to a microservice does not occur. In some examples, this value can be determined in response to user input, can be determined automatically, and/or there can be a default value used where no value is otherwise specified.

After operation 504, process flow 500 moves to operation 506.

Operation 506 depicts determining a value for a MCSC. This can be a value for how many cold starts should occur per measurement period to indicate conversion of a function to a microservice. Where a number of cold starts period is less than the MCSC, then it can be that a conversion of a function to a microservice does not occur. In some examples, this value can be determined in response to user input, can be determined automatically, and/or there can be a default value used where no value is otherwise specified.

After operation 506, process flow 500 moves to operation 508.

Operation 508 depicts determining a value for a PSP. This can indicate during what percentage of measurement periods MIT and MCSC metrics should be met to convert a function to a microservice. In some examples, this value can be determined in response to user input, can be determined automatically, and/or there can be a default value used where no value is otherwise specified.

After operation 508, process flow 500 moves to operation 510.

Operation 510 depicts determining a value for a MMPC. This can indicate a minimum number of measurement periods that should be observed before a decision on whether to convert a function to a microservice is made. In some examples, this value can be determined in response to user input, can be determined automatically, and/or there can be a default value used where no value is otherwise specified.

After operation 510, process flow 500 moves to operation 512.

Operation 512 depicts determining whether the MIT and MCSC are at least the PSP level for the last MMPC periods. That is, it can be determined for what percentage of measurement periods both the MIT and MCSC standards are met to indicate converting a function to a microservice, and it can be determined whether this percentage is at least as great as the PSP.

Where in operation 512 it is determined that the MIT and MCSC are at least the PSP level for the last MMPC periods, process flow 500 moves to operation 514. Instead, where in operation 512 it is determined that the MIT and MCSC are at least the PSP level for the last MMPC periods, process flow 500 moves to 516, where process flow 500 ends.

Operation 514 is reached from operation 512 where it is determined that the MIT and MCSC are at least the PSP level for the last MMPC periods. Operation 514 depicts converting the function to a microservice. In some examples, this can comprise converting a function of functions 112 of FIG. 1 to a microservice of microservices 114.

After operation 514, process flow 500 moves to 516, where process flow 500 ends.

FIG. 6 illustrates an example process flow 600 that can facilitate converting functions to microservices, in accordance with an embodiment of this disclosure. In some examples, one or more embodiments of process flow 600 can be implemented by converting functions to microservices component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts executing a group of containerized functions. That is, containerized functions can be deployed, which can be similar to functions 112 of FIG. 1.

After operation 604, process flow 600 moves to operation 606.

Operation 606 depicts monitoring a containerized function of the group of containerized functions for a number of iterations of the containerized function, respective iterations of the number of iterations being for a defined amount of time, and the containerized function is configured to execute a function. That is, the containerized function can be evaluated for at least MMPC periods.

After operation 606, process flow 600 moves to operation 608.

Operation 608 depicts, for the respective iterations, determining respective upper limits of amounts of time for which the containerized function is idle, and determining respective numbers of cold starts of the containerized function. That is, for the at least MMPC periods, the containerized function can be evaluated for MIT and MSCS metrics.

In some examples, the respective numbers of cold starts of the containerized function corresponds to instances of the containerized function being provisioned in response to attempts to invoke the containerized function. That is, starting a function after an idle period can introduce a cold start, where the function is provisioned (which takes time) before a call can be made against the function.

After operation 608, process flow 600 moves to operation 610.

Operation 610 depicts determining whether a percentage of the respective iterations, for which corresponding upper limits, of the respective upper limits, on amount of time for which the containerized function is idle, is below a threshold idleness value, and for which corresponding numbers of cold starts, of the respective numbers of cold starts, are above a threshold cold start value. That is, it can be determined whether the MIT and MSCS metrics both indicate conversion to a microservice for at least a PSP of the periods.

After operation 610, process flow 600 moves to operation 612.

Operation 612 depicts, in response to determining that the percentage of the respective iterations is above a threshold successful probes value, deploying a microservice that is configured to execute the function, and terminating deployment of the containerized function. That is, when the MIT and MSCS metrics both indicate conversion to a microservice for at least a PSP of the periods, the function can be converted to a microservice.

In some examples, a first amount of time associated with a first invocation the containerized function that occurs independently of a cold start of the cold starts is less than a second amount of time associated with a second invocation of the containerized function that occurs with the cold start. That is, a cold start can prolong a response time, and thus negatively impact service level agreement (SLA) metrics as they relate to responsiveness.

In some examples, deploying the microservice is performed by a continuous integration and continuous deployment component. This can be similar to CI/CD 204 of FIG. 2.

In some examples, the containerized function is a first containerized function, and the microservice is configured to call a second containerized function of the group of containerized functions. In some examples, the microservice is configured to be called by the group of containerized functions. That is, a computer service can be made up of both functions and microservices, and the functions and microservices can be configured to invoke each other.

After operation 612, process flow 600 moves to 614, where process flow 600 ends.

FIG. 7 illustrates an example process flow 700 that can facilitate converting functions to microservices, in accordance with an embodiment of this disclosure. In some examples, one or more embodiments of process flow 700 can be implemented by converting functions to microservices component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

In some examples where process flow 700 is implemented in conjunction with process flow 600 of FIG. 6, the number of iterations is a first number of iterations, the defined amount of time is a first defined amount of time, the percentage is a first percentage, and the threshold successful probes value is a first successful probes value.

Operation 704 depicts monitoring the microservice for a second number of iterations of the containerized function for a second defined amount of time. That is, the microservice can be monitored similar to how the function is monitored in process flow 600, and its metrics can be evaluated.

After operation 704, process flow 700 moves to operation 706.

Operation 706 depicts in response to determining that a second percentage of the respective second iterations is below a second threshold successful probes value, redeploying the containerized function, and terminating deployment of the microservice. That is, when a percentage of successful (in terms of supporting conversion of a function to a microservice) measurements of MIT and MSCS metrics drop below a specified PSP, the microservice can be converted back into a function.

After operation 706, process flow 700 moves to 708, where process flow 700 ends.

FIG. 8 illustrates an example process flow 800 that can facilitate converting functions to microservices, in accordance with an embodiment of this disclosure. In some examples, one or more embodiments of process flow 800 can be implemented by converting functions to microservices component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, process flow 900 of FIG. 9, and/or process flow 1000 of FIG. 10.

In some examples where process flow 800 is implemented in conjunction with process flow 600 of FIG. 6, deploying the microservice produces a deployed microservice instance. Process flow 800 can be used to implement operation 612.

Process flow 800 begins with 802, and moves to operation 804.

Operation 804 depicts accessing source code of the function from a repository. That is, between the source code for the functions being converted to a microservice can be acquired (such as by accessing a repository that stores the source code, like repository 116 of FIG. 1).

After operation 804, process flow 800 moves to operation 806.

Operation 806 depicts packaging the source code into a microservice image. That is, the source code can be packaged into a container image, such as an image stored in image registry 208 of FIG. 2.

After operation 806, process flow 800 moves to operation 808.

Operation 808 depicts deploying the microservice image to produce the deployed microservice instance. That is, the image created in operation 806 can be deployed.

After operation 808, process flow 800 moves to 810, where process flow 800 ends.

FIG. 9 illustrates an example process flow 900 that can facilitate converting functions to microservices, in accordance with an embodiment of this disclosure. In some examples, one or more embodiments of process flow 900 can be implemented by converting functions to microservices component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts monitoring a containerized function for recurring measurement periods. In some examples, operation 904 can be implemented in a similar manner as operations 604-606 of FIG. 6.

After operation 904, process flow 900 moves to operation 906.

Operation 906 depicts, for respective recurring measurement periods of the recurring measurement periods, determining respective upper limit idle times of the containerized function, and determining respective numbers of cold starts of the containerized function. In some examples, operation 906 can be implemented in a similar manner as operation 608 of FIG. 6.

In some examples, the respective upper limit idle times indicates a measured idle time of the containerized function per recurring measurement period of the recurring measurement periods. That is, it can be that, where measured idle time per measurement period is larger than MIT, a conversion to a microservice will not be considered.

After operation 906, process flow 900 moves to operation 908.

Operation 908 depicts determining a percentage of the recurring measurement periods where any respective upper limit idle times of the respective upper limit idle times are below a first value, and where any respective number of cold starts of the respective numbers of cold starts are above a second value. In some examples, operation 908 can be implemented in a similar manner as operation 610 of FIG. 6.

After operation 908, process flow 900 moves to operation 910.

Operation 910 depicts, in response to determining that the percentage of the recurring measurement periods is above a threshold percentage of successful probes, deploying a microservice that is configured to execute a function that corresponds to the containerized function. In some examples, operation 910 can be implemented in a similar manner as operation 612 of FIG. 6.

In some examples, operation 910 comprises monitoring the microservice for second recurring measurement periods, and in response to determining that a second percentage of the second recurring measurement periods is below a second threshold percentage of successful probes, deploying the containerized function. In some examples, deploying the containerized function comprises terminating deployment of the microservice. That is, when metrics that supported converting the function to a microservice are no longer met, the microservice can be converted back into a function.

In some examples, deploying the microservice further comprises terminating deployment of the containerized function.

In some examples, the threshold percentage of successful probes indicates a number of recurring measurement periods of the recurring measurement periods for which any respective upper limit idle times of the respective upper limit idle times are below the first value and any respective number of cold starts of the respective numbers of cold starts are above the second value.

After operation 910, process flow 900 moves to 912, where process flow 900 ends.

FIG. 10 illustrates another example process flow 1000 that can facilitate converting functions to microservices, in accordance with an embodiment of this disclosure. In some examples, one or more embodiments of process flow 1000 can be implemented by converting functions to microservices component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts, for recurring measurement periods during which a containerized function is monitored, determining respective upper limit idle times of the containerized function, and determining respective numbers of cold starts of the containerized function. In some examples, operation 1004 can be implemented in a similar manner as operations 604-608 of FIG. 6.

In some examples the respective upper limit idle times comprise respective maximum idle times. This can be a MIT.

After operation 1004, process flow 1000 moves to operation 1006.

Operation 1006 depicts determining a percentage of the recurring measurement periods for which at least one respective upper limit idle time of the respective upper limit idle times is below a first value, and for which at least one respective number of cold start of the respective numbers of cold starts is above a second value. In some examples, operation 1006 can be implemented in a similar manner as operation 610 of FIG. 6.

After operation 1006, process flow 1000 moves to operation 1008.

Operation 1008 depicts, in response to determining that the percentage of the recurring measurement periods is above a threshold percentage of successful probes, deploying a microservice that has been determined to be able to execute a function that corresponds to the containerized function. In some examples, operation 1008 can be implemented in a similar manner as operation 612 of FIG. 6.

In some examples, operation 1008 comprises, after deploying the microservice, and in response to determining that a second percentage of second recurring measurement periods is below a second threshold percentage of successful probes, deploying the containerized function. That is, conversion of a microservice to a function can be performed, such as when metrics supporting conversion to a microservice are no longer met.

In some examples, a third value of the threshold percentage of successful probes equals a fourth value of the second threshold percentage of successful probes. That is, the threshold value for converting a function to a microservice can be the same value used in converting a microservice to a function.

In some examples, a third value of the threshold percentage of successful probes differs from a fourth value of the second threshold percentage of successful probes. That is, there can be different thresholds used between converting a function to a microservice and converting a microservice to a function. This can be done, for example, to avoid oscillating between a microservice and a function when the percentage of successful probes varies around the threshold value. For example, converting a function to a microservice can be performed when over 70% of probes are successful, and converting a microservice to a function can be performed when fewer than 60% of probes are successful.

In some examples, deploying the microservice comprises accessing source code of the function from a repository, and deploying the containerized function comprises accessing the source code of the function from the repository. That is, the same code that performs the same can be deployed in both function and microservice forms.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of server 102 and/or remote computer 106 of FIG. 1.

In some examples, computing environment 1100 can implement one or more embodiments of the process flows of FIGS. 5-10 to facilitate converting functions to microservices.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component.” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that, in response to execution by the processor, cause the system to perform operations, comprising:
executing a group of containerized functions;
monitoring a containerized function of the group of containerized functions for a number of iterations of the containerized function, respective iterations of the number of iterations being for a defined amount of time, wherein the containerized function is configured to execute a function;
for the respective iterations,
determining respective upper limits of amounts of time for which the containerized function is idle, and
determining respective numbers of cold starts of the containerized function;
determining whether a percentage of the respective iterations, for which corresponding upper limits, of the respective upper limits, on amount of time for which the containerized function is idle, is below a threshold idleness value, and for which corresponding numbers of cold starts, of the respective numbers of cold starts, are above a threshold cold start value;
in response to determining that the percentage of the respective iterations is above a threshold successful probes value,
deploying a microservice that is configured to execute the function, and
terminating deployment of the containerized function.

2. The system of claim 1, wherein the number of iterations is a first number of iterations, wherein the defined amount of time is a first defined amount of time, wherein the percentage is a first percentage, wherein the threshold successful probes value is a first successful probes value, and wherein the operations further comprise:
monitoring the microservice for a second number of iterations of the containerized function for a second defined amount of time; and
in response to determining that a second percentage of the respective second iterations is below a second threshold successful probes value,
redeploying the containerized function, and
terminating deployment of the microservice.

3. The system of claim 1, wherein the respective numbers of cold starts of the containerized function corresponds to instances of the containerized function being provisioned in response to attempts to invoke the containerized function.

4. The system of claim 1, wherein a first amount of time associated with a first invocation the containerized function that occurs independently of a cold start of the cold starts is less than a second amount of time associated with a second invocation of the containerized function that occurs with the cold start.

5. The system of claim 1, wherein the containerized function is a first containerized function, and wherein the microservice is configured to call a second containerized function of the group of containerized functions.

6. The system of claim 1, wherein the microservice is configured to be called by the group of containerized functions.

7. The system of claim 1, wherein deploying the microservice produces a deployed microservice instance, and wherein deploying the microservice that is configured to execute the function comprises:
accessing source code of the function from a repository;
packaging the source code into a microservice image; and
deploying the microservice image to produce the deployed microservice instance.

8. The system of claim 1, wherein deploying the microservice is performed by a continuous integration and continuous deployment component.

9. A method, comprising:
monitoring, by a system comprising a processor, a containerized function for recurring measurement periods;
for respective recurring measurement periods of the recurring measurement periods, determining, by the system, respective upper limit idle times of the containerized function, and determining, by the system, respective numbers of cold starts of the containerized function;
determining, by the system, a percentage of the recurring measurement periods where any respective upper limit idle times of the respective upper limit idle times are below a first value, and where any respective number of cold starts of the respective numbers of cold starts are above a second value; and
in response to determining that the percentage of the recurring measurement periods is above a threshold percentage of successful probes, deploying, by the system, a microservice that is configured to execute a function that corresponds to the containerized function.

10. The method of claim 9, further comprising:
monitoring, by the system, the microservice for second recurring measurement periods; and
in response to determining that a second percentage of the second recurring measurement periods is below a second threshold percentage of successful probes, deploying, by the system, the containerized function.

11. The method of claim 10, wherein deploying the containerized function comprises:
terminating deployment of the microservice.

12. The method of claim 9, wherein deploying the microservice further comprises:
terminating deployment of the containerized function.

13. The method of claim 9, wherein the respective upper limit idle times indicates a measured idle time of the containerized function per recurring measurement period of the recurring measurement periods.

14. The method of claim 9, wherein the threshold percentage of successful probes indicates a number of recurring measurement periods of the recurring measurement periods for which any respective upper limit idle times of the respective upper limit idle times are below the first value and any respective number of cold starts of the respective numbers of cold starts are above the second value.

15. A non-transitory computer-readable medium comprising instructions that, in response to execution, cause a system comprising a processor to perform operations, comprising:
for recurring measurement periods during which a containerized function is monitored, determining respective upper limit idle times of the containerized function, and determining respective numbers of cold starts of the containerized function;
determining a percentage of the recurring measurement periods for which at least one respective upper limit idle time of the respective upper limit idle times is below a first value, and for which at least one respective number of cold start of the respective numbers of cold starts is above a second value; and
in response to determining that the percentage of the recurring measurement periods is above a threshold percentage of successful probes, deploying a microservice that has been determined to be able to execute a function that corresponds to the containerized function.

16. The non-transitory computer-readable medium of claim 15, wherein the operations further comprise:
after deploying the microservice, and in response to determining that a second percentage of second recurring measurement periods is below a second threshold percentage of successful probes, deploying the containerized function.

17. The non-transitory computer-readable medium of claim 16, wherein a third value of the threshold percentage of successful probes equals a fourth value of the second threshold percentage of successful probes.

18. The non-transitory computer-readable medium of claim 16, wherein a third value of the threshold percentage of successful probes differs from a fourth value of the second threshold percentage of successful probes.

19. The non-transitory computer-readable medium of claim 15, wherein deploying the microservice comprises:
accessing source code of the function from a repository, and wherein deploying the containerized function comprises accessing the source code of the function from the repository.

20. The non-transitory computer-readable medium of claim 15, wherein the respective upper limit idle times comprise respective maximum idle times.
